(19) United States
(12) Patent Application Publication
(10) Pub. No.: US 2019/0000021 A1
(43) Pub. Date: Jan. 3, 2019

(54) RAINMAKING DEVICE

(71) Applicant: Bill Wen-Chang Huang, New Taipei City (TW)

(72) Inventor: Bill Wen-Chang Huang, New Taipei City (TW)

(21) Appl. No.: 15/640,606

(22) Filed: Jul. 3, 2017

(51) Int. Cl. A01G 15/00; B05B 7/00

(52) U.S. Cl. CPC A01G 15/00; B05B 7/0087

(57) ABSTRACT

The rainmaking device includes a first pipe member, a connection member, and a second pipe member. The first pipe member is installed adjacent to a warm water source. The first pipe member has an intake facing the warm water source. A number of blowers configured around the intake. The connection member is connected between the first and second pipe members. The second pipe member has a cone shape whose aperture gradually decreases upward. Through the blowers, the first and second pipe members, wet air above the warm water source of 22-25 degrees is drawn up to a high altitude. Tiny ice crystals attract surrounding water vapor and become larger and heavier. They will then drop as rain when the buoyance can no longer support them. The latent heat released would power the convection of surrounding air so that a chain reaction may be triggered, and cumulonimbus would become rain and fall.

### BACKGROUND OF THE INVENTION

### (a) Technical Field of the Invention

The present invention generally relates to rainmaking and, more particularly, to a rainmaking device by delivering wet air to high altitude.

### (b) Description of the Prior Art

As early as 1800, a new Yorker G. H. Bell proposed to build a pipe 1500-feet tall and claimed to make rain by blowing wind upward through the pipe. According to research, there is a 1% chance of precipitation by delivering the wet air upon a pond of 22-25 degrees Celsius to the sky. Most of the wet air becomes hot air bubbles of indefinite form with a lighter specific weight. If wind brings the wet air along a mountainside, and a small dam or a terraced field is provided halfway up the mountain of 3000 meters above sea level, a big pipe may be constructed from there to the mountaintop, and a canvas pipe of 1000 meters long is further provided from the mountaintop so that the wet air may reach even higher altitude, and the chance of precipitation may be even greater.

In 1946, Dr. Bernard Vonnegut taught the rainmaking method of spreading silver iodide into cumulonimbus. However an aircraft is required, and the process is costly and troublesome.

### SUMMARY OF THE INVENTION

Therefore, the present invention provides a novel rainmaking device that does not require the spreading of silver iodide into cumulonimbus.

The rainmaking device includes a first pipe member, a connection member, and a second pipe member. The first pipe member is installed adjacent to a warm water source. The first pipe member is hollow and made of a metallic material, and has an intake at a bottom end facing the warm water source. A number of blowers configured around the intake. The connection member is hollow and made of a metallic material, and a bottom end of the connection member is joined to a top end of the first pipe member. The second pipe member is hollow and made of canvas. A bottom end of the second pipe member is joined to a top end of the connection member, and the second pipe member has a cone shape whose aperture gradually decreases as the second pipe member extends upward.

Through the blowers, the first pipe member, and the second pipe member, wet air above the warm water source such as a dam or a pond of 22-25 degrees is drawn up to a high altitude (e.g., 5000 meters). The temperature would drop down to minus 7 degree. Tiny ice crystals attract surrounding water vapor and become larger and heavier. They will then drop as rain when the buoyance can no longer support them. The latent heat released would power the convection of surrounding air so that they may thrust out of Troposphere, and into Stratosphere. Then a chain reaction may be triggered, and cumulonimbus within 50 or 60 kilometers radius would all become rain and fall.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a side-view diagram showing a rainmaking device according to an embodiment of the present invention.

FIG. 2 is a side-view diagram showing a rainmaking device according to another embodiment of the present invention.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

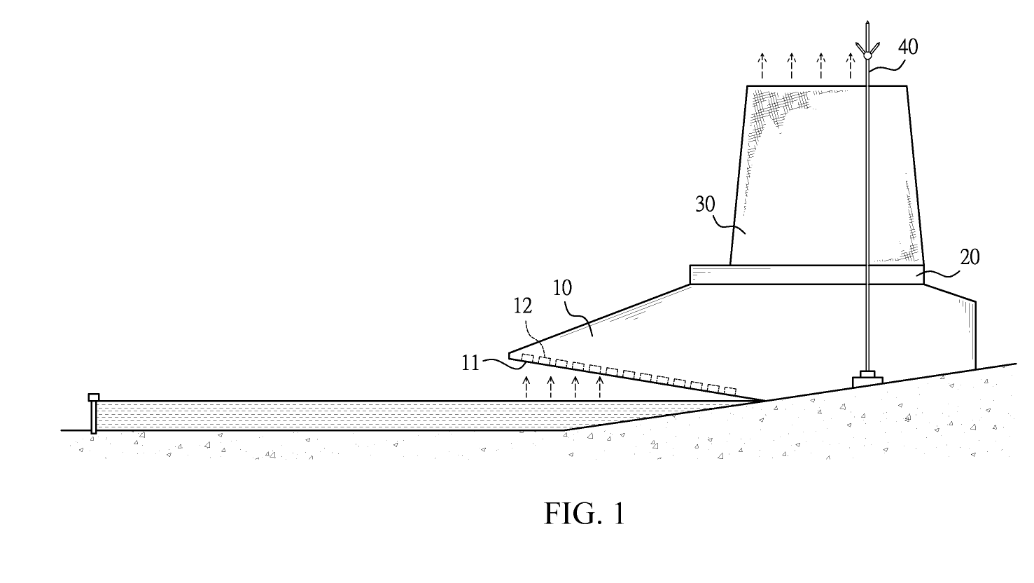

As shown in FIG. 1, a rainmaking device according to an embodiment of the present invention includes a first pipe member 10, a connection member 20, and a second pipe member 30.

The first pipe member 10 is installed adjacent to a warm water source such as a dam 90. The first pipe member 10 is hollow and made of a metallic material. The first pipe member 10 has an intake 11 at a bottom end facing the warm water source. A number of blowers 12 are configured around the intake 11.

The connection member 20 is hollow and made of a metallic material. A bottom end of the connection member 20 is joined to a top end of the first pipe member 10.

The second pipe member 30 is hollow and made of canvas. A bottom end of the second pipe member 30 is joined to a top end of the connection member 20. The second pipe member 30 has a cone shape whose aperture gradually decreases as the second pipe member 30 extends upward.

In the present embodiment, a lighting arrestor 40 is configured inside and extended upward within the first pipe member 10, the connection member 20, and the second pipe member 30.

The operation of the rainmaking device is as follow.

Through the blowers 12, the first pipe member 10, and the second pipe member 30, wet air above the warm water source such as the dam 90 of 22-25 degrees is drawn up to 1300 meters high. As there is side wind and without the confinement of the pipes, hot air bubbles are formed and rise at very low speed. As the surrounding temperature drops, the hot air bubbles become visible clouds, just like a sea of clouds that we see when we climb Sierra Nev.

When the blowers 12 have drawn enough wet air, the internal pressure would raise the canvas-made second pipe member 30. The wet air rises upward at very low speed and becomes hot air bubbles of indefinite form. As the temperature gradually drops, the hot air bubbles first become visible clouds and may drift to other places like a sea of clouds when we climb Sierra Nev. The position of the second pipe member 30 is determined based on where the clouds stay around.

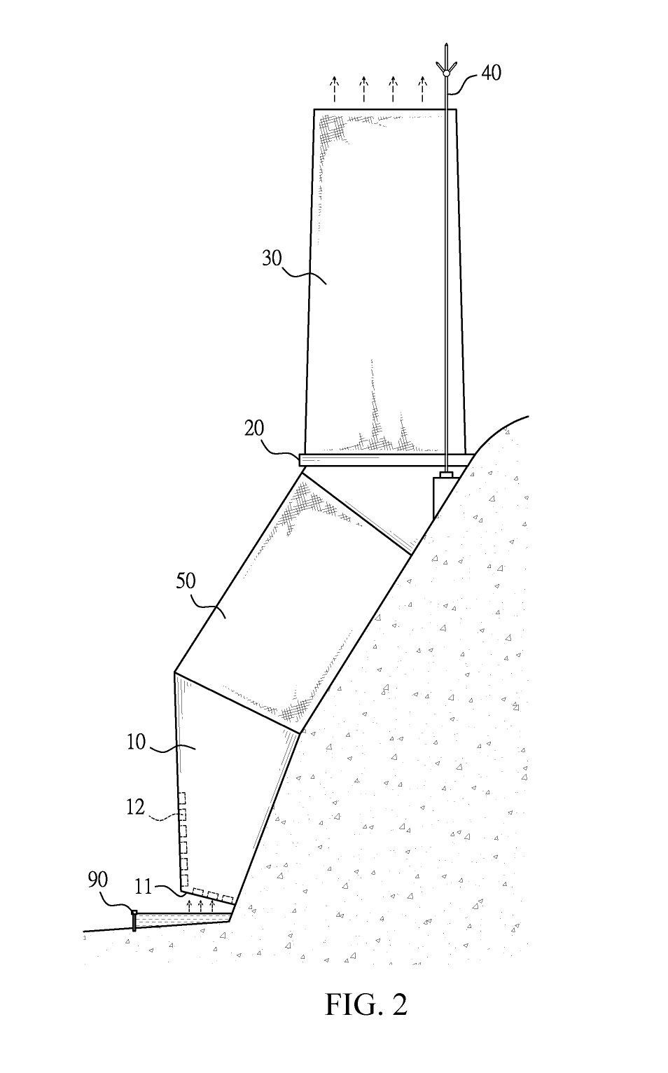

As shown in FIG. 2, a rainmaking device according to another embodiment of the present invention further include a third pipe member 50 connected between the first pipe member 10 and the connection member 20. The third pipe member 50 is hollow and made of canvas for lengthening the rainmaking device along a hillside.

As shown in FIG. 2, the present embodiment may reach 4000 meters in height. The intake 11 at the bottom end of the first pipe member 10 is positioned above water level for 0.4 to 20 meters. The output pressure of the each blower 12 is at most 0.01 kg/cm². The third pipe member 50 is constructed along a hillside and has cross-sectional area greater than 200,000 square meters. The third pipe member 50 is then connected to the connection member 20 on the hill top. The connection member 20 has a diameter of 500 meters, and connects to the second pipe member 30 whose height is about 1000 meters with a lighting arrestor. The diameter of the second pipe member 30 gradually reduces to 400 meters as it rises upward. The inner pressure created by the blowers 12 raise the canvas-made second pipe member 30. The wet air rises up to 4000 meters high. The temperature would drop down to minus 7 degree. Tiny ice crystals attract surrounding water vapor and become larger and heavier. They will then drop as rain when the buoyance can no longer support them. The latent heat released would power the convection of surrounding air so that they may thrust out of Troposphere, and into Stratosphere. Then a chain reaction may be triggered, and cumulonimbus within 50 or 60 kilometers radius would all become rain and fall.

The water source may be kept warm in dry or cold places, for example, by building dike along coast around 20-meter isometric line to prevent cold current.

Alternatively, a steam ejection unit may be configured inside the second pipe member 30 to blow steam into the second pipe member 30 and to enhance rainmaking efficiency. Compared to rainmaking by silver iodide, the steam ejection unit creates rain of greater volume but of smaller coverage.

The water vapor from the warm water source may be considered as the detonator to rainmaking. On the other hand, the pipe members function as a triggering mechanism. And the low-pressure air is detonated to make rain.

The structures shown in FIGS. 1 and 2 may be integrated and applied together, or employed separately.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A rainmaking device, comprising:
a first pipe member installed adjacent to a warm water source, where the first pipe member is hollow and made of a metallic material, the first pipe member has an intake at a bottom end facing the warm water source;
a plurality of blowers configured around the intake;
a connection member where the connection member is hollow and made of a metallic material, and a bottom end of the connection member is joined to a top end of the first pipe member; and
a second pipe member where the second pipe member is hollow and made of canvas, a bottom end of the second pipe member is joined to a top end of the connection member, and the second pipe member has a cone shape whose aperture gradually decreases as the second pipe member extends upward.

2. The rainmaking device according to claim 1, further comprising a lighting arrestor unit inside the first pipe member, the connection member, and the second pipe member.

3. The rainmaking device according to claim 1, further comprising a third pipe member connected between the first pipe member and the connection member, wherein the third pipe member is hollow and is made of canvas.

4. The rainmaking device according to claim 1, further comprising a steam ejection unit inside the second pipe member.

5. The rainmaking device according to claim 1, wherein the first pipe member is configured first; and the position of the second pipe member is determined based on where the clouds stay around.
